(19) United States
(12) Patent Application Publication
(10) Pub. No.: US 2026/0351988 A1
(43) Pub. Date: Nov. 5, 2026

(54) GENERATOR, CONTROL METHOD FOR GENERATOR, AND POWER GENERATION AND ENERGY STORAGE SYSTEM

(71) Applicant: ECOFLOW INC., Shenzhen (CN)

(72) Inventors: Xing ZHOU, Shenzhen (CN); Lei WANG, Shenzhen (CN); Xi CHEN, Shenzhen (CN)

(21) Appl. No.: 19/708,575

(22) Filed: Jun. 15, 2026

Related U.S. Application Data
(63) Continuation of application No. PCT/CN2025/077525, filed on Feb. 17, 2025.

(30) Foreign Application Priority Data
Feb. 23, 2024 (CN) 202410204298.1

(51) Int. Cl. H02J 7/14; H02J 7/00

(52) U.S. Cl. CPC H02J 7/1423; H02J 7/855

(57) ABSTRACT

A generator includes a starting battery module, a first control module, a power generation module, a switch module, and a charging terminal. The charging terminal is configured to be connected to an energy storage device, to obtain electric energy from the energy storage device. The switch module is connected between the starting battery module and the charging terminal, and is configured to establish or disconnect a connection between the starting battery module and the charging terminal. The first control module is configured to: when the energy storage device is connected and the power generation module is not started, control the switch module to establish the connection between the starting battery module and the charging terminal, to charge the starting battery module.

### CROSS-REFERENCE TO RELATED APPLICATIONS

This application is a continuation application of PCT patent application No. PCT/CN2025/077525, filed on Feb. 17, 2025, which claims priority to Chinese Patent Application No. 202410204298.1, field on Feb. 23, 2024, the content of all of which is incorporated herein by reference in their entirety.

### TECHNICAL FIELD

This application relates to the field of generator technologies, and specifically, to a generator, a control method for a generator, and a power generation and energy storage system.

### BACKGROUND

When a generator is electrically started, a reverse drive module or a starter motor is driven by an internal battery to start the generator, and the starting process needs to consume power of the battery. After the generator is started, the generator may generate power and recharge the battery. However, if the generator is in a standby state for a long time, the battery needs to provide basic working power to a component such as a controller inside the generator. Consequently, the power of the battery is exhausted, and the generator cannot be electrically started. A user needs to start the generator only by a manual pulling operation, resulting in relatively poor user experience.

### SUMMARY

According to embodiments of this application, a generator, a control method for a generator, and a power generation and energy storage system are provided.

A first aspect of this application provides a generator, where the generator includes a starting battery module, a first control module, a power generation module, a switch module, and a charging terminal; the charging terminal is configured to be connected to an energy storage device, to obtain electric energy from the energy storage device; the switch module is connected between the starting battery module and the charging terminal, and is configured to establish or disconnect a connection between the starting battery module and the charging terminal; and the first control module is configured to: when the energy storage device is connected and the power generation module is not started, control the switch module to establish the connection between the starting battery module and the charging terminal, to charge the starting battery module.

A second aspect of this application provides a control method for a generator, applied to the generator described above. The control method includes: detecting a connection status of the energy storage device; detecting a starting status of the power generation module; and when the energy storage device is connected and the power generation module is not started, controlling the switch module to establish the connection between the starting battery module and the charging terminal, to charge the starting battery module.

A third aspect of this application provides a power generation and energy storage system, including an energy storage device and the generator described above.

A fourth aspect of this application provides an electronic device, including a processor, and a memory, having an executable instruction of the processor stored therein, where the processor is configured to perform, by executing the executable instruction, the control method described above.

A fifth aspect of this application provides a computer-readable storage medium, having a computer program stored therein. The computer program implements, when executed by a processor, the control method described above.

Details of one or more embodiments of this application are provided in the following accompanying drawings and descriptions. Other features, objectives, and advantages of this application become obvious with reference to the specification, the accompanying drawings, and the claims.

### BRIEF DESCRIPTION OF THE DRAWINGS

To describe the technical solutions in embodiments or exemplary technologies of this application more clearly, the following briefly describes the accompanying drawings required for describing the embodiments or the exemplary technologies. Apparently, the accompanying drawings in the following description show merely some embodiments of this application, and a person of ordinary skill in the art may still derive drawings of other embodiments from these accompanying drawings without creative efforts.

FIG. 1 is a schematic block diagram of a generator according to an embodiment of this application;

FIG. 2 is a schematic block diagram of a generator according to another embodiment of this application;

FIG. 3 is a schematic block diagram of a generator according to still another embodiment of this application;

FIG. 4 is a schematic circuit block diagram of a generator according to an embodiment of this application;

FIG. 5 is a flowchart of a control method for a generator according to an embodiment of this application;

FIG. 6 is a partial flowchart of a control method for a generator according to an embodiment of this application;

FIG. 7 is a partial flowchart of a control method for a generator according to another embodiment of this application; and

FIG. 8 is a schematic block diagram of a power generation and energy storage system according to an embodiment of this application.

### DETAILED DESCRIPTION

It needs to be noted that in the specification, claims, and the accompanying drawings of this application, the terms “first” and “second” are intended to distinguish between similar objects instead of describing a specific order or sequence.

It should be additionally noted that a method disclosed in the embodiments of this application or a method shown in the flowchart includes one or more steps for implementing the method, and performing orders of the plurality of steps may be exchangeable, where some steps may alternatively be omitted.

Some embodiments are described below with reference to the accompanying drawings. In absence of conflicts, the following embodiments and features in the embodiments may be combined.

In a related technology, when a generator is electrically started, a reverse drive module or a starter motor is driven by an internal battery to start the generator, and the starting process needs to consume power of the battery. After the generator is started, the generator may generate power and recharge the battery. However, if the generator is in a standby state for a long time, the battery needs to provide basic working power to a component such as a controller inside the generator. Consequently, the power of the battery is exhausted, and the generator cannot be electrically started. A user needs to start the generator only by a manual pulling operation, resulting in relatively poor user experience.

Therefore, the embodiments of this application provide a generator and a control method for a generator, so that when an energy storage device is connected to the generator and a power generation module of the generator is not started, the energy storage device can charge a starting battery module, thereby preventing the generator from failing to be electrically started because power of the starting battery module is exhausted, reducing a case in which a user needs to start the generator by a manual pulling operation, and improving user experience.

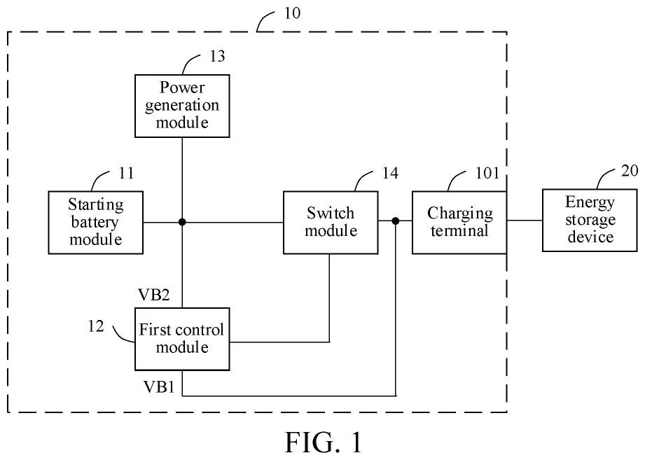

Refer to FIG. 1. FIG. 1 is a functional module diagram of a generator 10 according to an embodiment of this application. As shown in FIG. 1, the generator 10 includes a starting battery module 11, a first control module 12, a power generation module 13, a switch module 14, and a charging terminal 101.

The charging terminal 101 is configured to be connected to an energy storage device 20, to obtain electric energy from the energy storage device 20. The switch module 14 is connected between the starting battery module 11 and the charging terminal 101, and is configured to establish or disconnect a connection between the starting battery module 11 and the charging terminal 101. The first control module 12 is configured to: when the energy storage device 20 is connected and the power generation module 13 is not started, control the switch module 14 to establish the connection between the starting battery module 11 and the charging terminal 101, to charge the starting battery module 11.

In some embodiments, a connection detection circuit may be disposed at the charging terminal 101. The connection detection circuit detects the charging terminal 101 and transmits a detection signal to the first control module 12 based on a detection result. The first control module 12 determines, based on the detection signal, whether the energy storage device 20 is connected. The connection detection circuit may generate the corresponding detection signal by detecting a voltage value or a pressure value of the charging terminal 101. In some other embodiments, after being connected to the generator 10, the energy storage device 20 may establish a communication connection to the first control module 12 to transmit a connection signal to the first control module 12. In this case, the first control module 12 may directly determine, based on whether the connection signal is received, whether the energy storage device 20 is connected.

In some other embodiments, the energy storage device 20 may be connected to a first interface (not shown in FIG. 1) of the generator 10 through a generator interface of the energy storage device 20 for a connection to the generator 10. For example, in this case, a connection detection circuit may be disposed at the first interface of the generator 10, and the connection detection circuit performs connection detection on the energy storage device 20, for example, detects a signal pin (for example, a connection detection pin) of the first interface. The connection detection circuit transmits a detection signal to the first control module 12 based on a detection result, and the first control module 12 determines, based on the detection signal, whether the energy storage device 20 is connected. The connection detection circuit may generate the corresponding detection signal by detecting a voltage value or a pressure value of the connection detection pin. Correspondingly, a connection detection circuit may alternatively be disposed on the generator interface of the energy storage device 20, to detect whether the generator 10 is connected. In some embodiments, the energy storage device 20 may actively output a voltage signal by using the connection detection pin, receive a feedback signal by using a feedback pin, and determine, based on the feedback signal, whether to be connected to the generator 10. When it is determined that the generator 10 is connected, the energy storage device 20 may actively output a voltage through the charging terminal 101, to provide electric energy to the generator 10.

In some embodiments, the first interface may be a composite interface including a communication pin and a power supply pin. In this case, the charging terminal 101 may be, for example, one or more power supply pins in the first interface of the generator 10. In some embodiments, the first interface may alternatively be a communication interface. In this case, the generator 10 may further include a second interface (a power interface). The energy storage device 20 performs power transmission to the generator through the second interface. In this case, the charging terminal 101 may be one or more power supply pins in the second interface. A form of the charging terminal 101 and a manner of connecting the energy storage device 20 and the generator 10 are not limited in this application.

In some embodiments, the switch module 14 may include a controllable switch, such as a relay, a contactor, or a power transistor.

In the generator 10 in this embodiment of this application, the switch module 14 is connected between the starting battery module 11 and the charging terminal 101. When the energy storage device 20 is connected to the generator 10 and the power generation module 13 is not started, the first control module 12 controls the switch module 14 to establish the connection between the starting battery module 11 and the charging terminal 101, so that the energy storage device 20 can charge the starting battery module 11 through the charging terminal 101 and the switch module 14. In this way, when the energy storage device 20 is connected to the generator 10 and the power generation module 13 is not started, the energy storage device 20 may be configured to charge the starting battery module 11, to prevent the starting battery module 11 from failing to be electrically started because power is exhausted when the power generation module 13 is in a standby state, thereby reducing a case in which a user needs to start the generator 10 by a manual pulling operation, and improving user experience.

Still refer to FIG. 1. In some embodiments, a first power supply terminal (VB1 shown in FIG. 1) of the first control module 12 may alternatively be connected to the charging terminal 101, to receive power supplied by the energy storage device 20. The first control module 12 is configured to be activated based on the power supplied by the energy storage device 20 and be powered up for running. Therefore, when the energy storage device 20 is connected and the power generation module 13 is not started, the energy storage device 20 may supply power to and activate the first control module 12, so that the first control module 12 is powered up for running, and further may control the switch module 14 to establish the connection between the starting battery module 11 and the charging terminal 101, to implement that the energy storage device 20 charges the starting battery module 11.

In a process in which the energy storage device 20 charges the starting battery module 11, the energy storage device 20 also continues supplying power to the first control module 12.

Certainly, it may be understood that, the first control module 12 may further include a second power supply terminal (VB2 shown in FIG. 1). The second power supply terminal is connected to the starting battery module 11. When the energy storage device 20 is not connected to the generator 10, the first control module 12 is activated based on power supplied by the starting battery module 11 and is powered up for running.

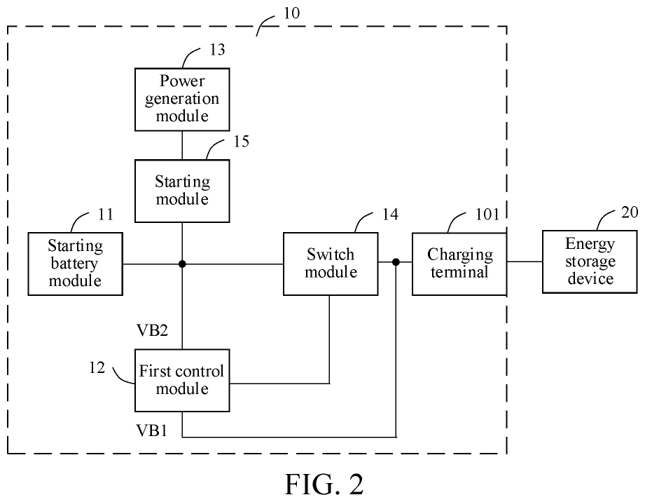

Refer to FIG. 2. In some embodiments, the generator 10 may further include a starting module 15, and the starting module 15 is connected between the switch module 14 and the power generation module 13.

The starting module 15 is configured to: when the switch module 14 is in an ON state, in response to a starting instruction for starting the power generation module 13, obtain power from the energy storage device 20 through the charging terminal 101 and provide a starting voltage to the power generation module 13.

Therefore, when the energy storage device 20 charges the starting battery module 11 through the switch module 14 that is in an ON state, if the generator 10 receives the starting instruction for starting the power generation module 13, the energy storage device 20 can further supply power to the starting module 15 through the charging terminal 101 and the switch module 14, to provide the starting voltage to the power generation module 13.

It may be understood that, the starting module 15 may further be connected to the starting battery module 11. In this case, when the energy storage device 20 is not connected and the generator 10 receives the starting instruction for starting the power generation module 13, the starting battery module 11 may provide the starting voltage for the power generation module 13.

In this embodiment of this application, the starting instruction may be transmitted by the energy storage device 20 to the first control module 12, and the first control module 12 transmits the starting instruction to the starting module 15. Alternatively, the generator 10 may further include a second control module, and the second control module is configured to control the power generation module 13 to be started. Based on this, the first control module 12 may transmit the starting instruction to the second control module, and the second control module controls, according to the starting instruction, the starting module 15 to provide the starting voltage to the power generation module 13.

It may be understood that, for example, the starting instruction may be transmitted by the energy storage device 20 to the first control module 12 in a wireless communication manner or a wired communication manner. For another example, the starting instruction may alternatively be transmitted by another mobile terminal to the first control module 12. In some other embodiments, a physical starting key or a touchable screen may further be disposed on the generator 10, and the starting instruction is transmitted to the first control module 12 by pressing the physical starting key or performing starting configuration on the touchable screen. A manner of transmitting or generating the starting instruction is not limited in this embodiment of this application.

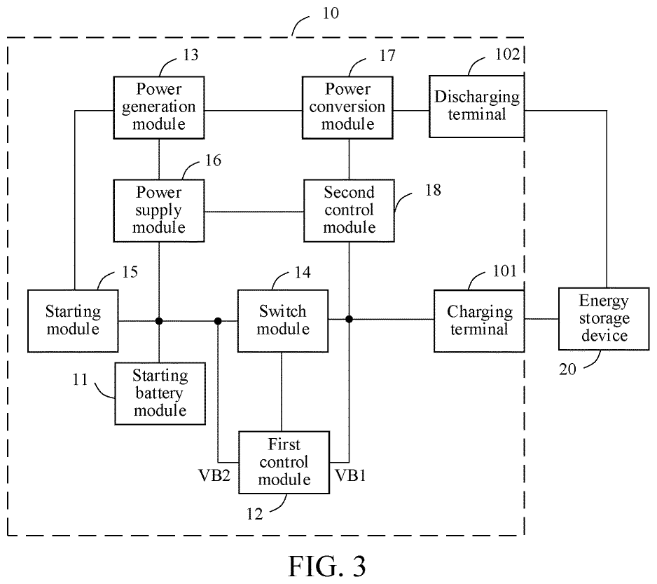

Further, referring to FIG. 3 together, in some embodiments, the generator 10 may further include a power supply module 16. One terminal of the power supply module 16 is connected to the power generation module 13, and the other terminal of the power supply module 16 is connected to the starting battery module 11 and the second power supply terminal VB2 of the first control module 12. The power supply module 16 is configured to: when the power generation module 13 has been started, convert an output voltage of the power generation module 13, charge the starting battery module 11, and supply power to the first control module 12.

That is, after the power generation module 13 is started, the power generation module 13 starts to generate electric energy. After the power supply module 16 performs voltage conversion on the electric energy generated by the power generation module 13, the electric energy may charge the starting battery module 11 and supply power to the first control module 12. Therefore, after the power generation module 13 is started, consumption of electric energy of the energy storage device 20 may be stopped, and the starting battery module 11 can continue to be recharged, thereby further preventing power of the starting battery module 11 from being exhausted.

In some embodiments, after the power generation module 13 is started, the first control module 12 may further transmit a corresponding starting signal to the energy storage device 20, and the energy storage device 20 may stop discharging to the charging terminal 101 according to the starting signal.

In some embodiments, after the power generation module 13 is started, the first control module 12 may further transmit a disconnection signal to the switch module 14, so that the switch module 14 disconnects the connection between the starting battery module 11 and the charging terminal 101, thereby interrupting the charging path from the energy storage device 20 to the starter battery module 11.

It may be understood that, the generator 10 further includes a discharging terminal 102, the discharging terminal 102 is connected to the power generation module 13, and the discharging terminal 102 is configured to be connected to the energy storage device 20 to charge the energy storage device 20. The power generation module 13 is further configured to: after being started, in response to a charging request of the energy storage device 20, charge the connected energy storage device 20 through the discharging terminal 102. Based on this, electric energy generated after the power generation module 13 is started may further be used for charging the energy storage device 20. It may be understood that, the foregoing discharging terminal 102 may alternatively be connected to another load device, to supply power to a connected load by using electric energy output by the power generation module 13. Further, the generator 10 may further include a power conversion module 17. The power conversion module 17 is connected between the power generation module 13 and the discharging terminal 102. After the power conversion module 17 performs voltage conversion on the electric energy output by the power generation module 13, the electric energy charges the energy storage device 20 through the discharging terminal 102.

Correspondingly, the generator 10 may further include a second control module 18, the second control module 18 is connected to the power conversion module 17, and the second control module 18 is configured to control the power conversion module 17 to work. When the energy storage device 20 is connected and the power generation module 13 is started, the second control module 18 may control, based on the charging requirement of the energy storage device 20, a power transistor in the power conversion module 17 to be turned on/off, to control the power conversion module 17 to perform voltage conversion on the electric energy output by the power generation module 13.

It may be understood that, a first power supply terminal of the second control module 18 may be connected to the power supply module 16. After the power generation module 13 is started, the power generation module 13 supplies power to the second control module 18 through the power supply module 16.

In some embodiments, the second power supply terminal of the second control module 18 may be connected to the charging terminal 101. When the energy storage device 20 is connected and the power generation module 13 is not started, the second control module 18 is activated based on power supplied by the energy storage device 20 and is powered up for running.

It may be understood that, in some embodiments, the energy storage device 20 may directly supply power to/charge the foregoing modules such as the first control module 12, the second control module 18, the starting module 15, and the starting battery module 11 by using a power supply voltage provided by the charging terminal 101. In this case, the first control module 12 and the second control module 18 are directly connected to the charging terminal 101, and the starting module 15 and the starting battery module 11 are directly connected to the charging terminal 101 through the switch module 14. In some other embodiments, if the voltage provided by the energy storage device 20 via the charging terminal 101 cannot directly supply power to the foregoing modules (for example, the voltage is excessively high or excessively low), the charging terminal 101 may perform voltage conversion through a DC/DC conversion unit, and then provide an adaptive voltage for the first control module 12, the second control module 18, the starting module 15, and the starting battery module 11. The DC/DC conversion unit may be, for example, a buck circuit, a boost circuit, or a buck/boost circuit. This is not limited in this application.

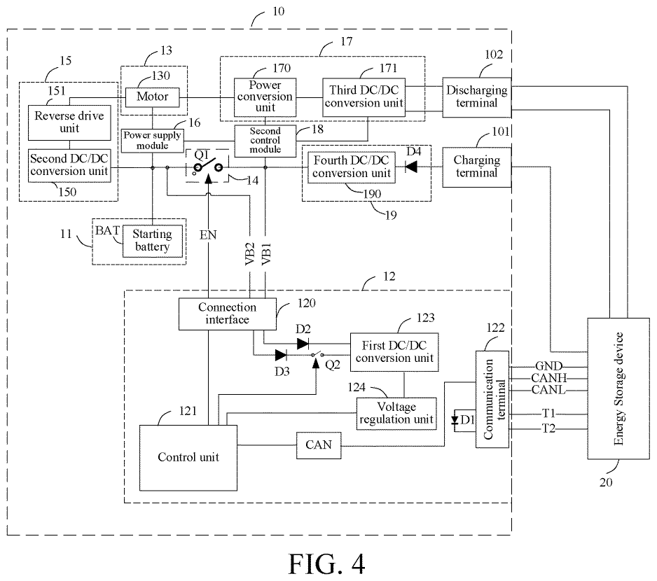

Refer to FIG. 4. FIG. 4 is a circuit block diagram of a generator 10 according to an embodiment of this application.

As shown in FIG. 4, the starting battery module 11 includes a starting battery BAT.

The first control module 12 may include a connection interface 120, a control unit 121, a communication terminal 122, a first DC/DC conversion unit 123, and a voltage regulation unit 124. The control unit 121 is connected to the switch module 14 via an enabling terminal in the connection interface 120, to control the switch module 14 to be turned on and off. The first DC/DC conversion unit 123 is connected to the charging terminal 101 through the first power supply terminal VB1, and is connected to the starting battery BAT and the power supply module 16 through the second power supply terminal VB2. A first end of the voltage regulation unit 124 is connected to the first DC/DC conversion unit 123, and a second end of the voltage regulation unit 124 is connected to a power supply terminal of the control unit 121. The first DC/DC conversion unit 123 is configured to perform voltage conversion on a voltage of the first power supply terminal VB1 or the second power supply terminal VB2 to obtain a first voltage, and output the first voltage to the voltage regulation unit 124. The voltage regulation unit 124 is configured to perform voltage conversion on the first voltage to obtain a second voltage, and provide the second voltage to the power supply terminal of the control unit 121, to supply power to the control unit 121.

In some embodiments, a voltage provided by the charging terminal 101 to the first power supply terminal VB1 may be 14 V, and a voltage provided by the starting battery BAT or the power supply module 16 to the second power supply terminal VB2 may be 12 V. In this way, when the energy storage device 20 is connected, and the charging terminal 101 provides the voltage, the first DC/DC conversion unit 123 preferentially obtains electric energy from the first power supply terminal VB1, that is, the energy storage device 20 preferentially supplies power to the first control module 12. For example, the first voltage may be 5 V, and the second voltage may be 3.3 V. That is, the first DC/DC conversion unit 123 is configured to convert the 14 V voltage provided by the first power supply terminal VB1 or the 12 V voltage provided by the second power supply terminal VB2 into 5 V. The voltage regulation unit 124 is configured to convert the 5 V voltage into the 3.3 V voltage, and provide the 3.3 V voltage to the power supply terminal of the control unit 121, to supply power to the control unit 121.

It may be understood that the foregoing values of the voltages are merely examples, and actual values of the voltages are not limited in this application.

The control unit 121 is communicatively connected to the energy storage device 20 via the communication terminal 122. When the energy storage device 20 is connected to the generator 10, the energy storage device 20 is electrically connected to the discharging terminal 102 and the charging terminal 101 of the generator 10, and the communication terminal 122 of the energy storage device 20 is communicatively connected to the communication terminal 122 of the first control module 12.

The first control module 12 may further include a first unidirectional conduction unit D1. A first end of the first unidirectional conduction unit D1 is connected to a first communication terminal T1 of the communication terminal 122, and a second end of the first unidirectional conduction unit D1 is connected to a second communication terminal T2 of the communication terminal 122. When the energy storage device 20 is connected to the generator 10, the energy storage device 20 transmits a first signal to the first communication terminal T1. The first unidirectional conduction unit D1 outputs a second signal to the second communication terminal T2 based on the first signal. The energy storage device 20 receives the second signal via the second communication terminal T2 and outputs electric energy to the charging terminal 101 based on the second signal. Further, the charging terminal 101 inputs the electric energy to the first DC/DC conversion unit 123 via the first power supply terminal VB1, and then provides the electric energy to the power supply terminal of the control unit 121 via the voltage regulation unit 124, to power up and activate the control unit 121. After the energy storage device 20 receives the second signal, a hardware handshake is implemented between the generator 10 and the energy storage device 20, so that the energy storage device 20 outputs electric energy to the charging terminal 101. In this way, when the generator 10 is turned off, when the energy storage device 20 is connected, a connection situation may be determined through a hardware handshake. During a normal hardware connection, working power is provided for each control module of the generator 10 to wake up the generator 10. A waste of power supplied during a connection fault is avoided. In addition, the generator 10 may be externally woken up and started.

In some embodiments, the first unidirectional conduction unit D1 may include a diode, a first end of the first unidirectional conduction unit D1 is an anode of the diode, and a second end of the second unidirectional conduction unit is a cathode of the diode.

After the control unit 121 is powered up and activated, if it is detected that the energy storage device 20 is connected and the power generation module 13 is not started, the switch module 14 is controlled to be turned on, so that the energy storage device 20 charges the starting battery BAT.

The switch module 14 includes a controllable switch Q1 such as a relay, a contactor, or a transistor. A first end of the controllable switch Q1 is connected to the charging terminal 101, and a second end of the controllable switch Q1 is connected to the starting battery BAT. A controlled end of the controllable switch Q1 is connected to the control unit 121 through an enabling end EN in the connection interface 120, to receive an enabling signal output by the control unit 121.

It may be understood that, the control unit 121 may determine, by detecting the first signal of the first communication terminal T1, whether the energy storage device 20 is connected. After the control unit 121 is powered up and run, if the first signal of the first communication terminal T1 is detected, it is determined that the generator 10 is in a hardware connection to the energy storage device 20.

It may be understood that the control unit 121 may directly or indirectly detect the first signal. For example, when the first signal is a voltage signal and is greater than a detection interval of the control unit 121, the first signal may be converted by a conversion circuit into a level signal adapted to the control unit 121, for example, a high-level signal of 3.3 V.

It may be understood that the first control module 12 may further include a second unidirectional conduction unit D2 and a third unidirectional conduction unit D3. A first end of the second unidirectional conduction unit D2 is connected to the first power supply terminal VB1, and a second end of the second unidirectional conduction unit D2 is connected to an input end of the first DC/DC conversion unit 123. A first end of the third unidirectional conduction unit D3 is connected to the second power supply terminal VB2, and a second end of the third unidirectional conduction unit D3 is connected to the input end of the first DC/DC conversion unit 123. The second unidirectional conduction unit D2 and the third unidirectional conduction unit D3 may be diodes, the first end of the second unidirectional conduction unit D2 and the first end of the third unidirectional conduction unit D3 are anodes of the diodes, and the second end of the second unidirectional conduction unit D2 and the second end of the third unidirectional conduction unit D3 are cathodes of the diodes.

In some embodiments, the first control module 12 may further include a power supply switch Q2. The power supply switch Q2 is connected between the third unidirectional conduction unit D3 and the first DC/DC conversion unit 123. When the starting battery BAT or the power generation module 13 needs to supply power to the second power supply terminal VB2 of the first control module 12, the first control module 12 controls the power supply switch Q2 to be turned on. For example, the power supply switch Q2 may be controlled to be turned on when the energy storage device 20 is not connected, and the power supply switch Q2 is controlled to be turned on after the energy storage device 20 is connected and the power generation module 13 is started.

In this embodiment of this application, the first control module 12 may be a power transmission control board of the generator 10. The connection interface 120, the control unit 121, the communication terminal 122, the first DC/DC conversion unit 123, and the voltage regulation unit 124 may all be integrated on the power transmission board. The control unit 121 may be a microcontroller unit 121 (MCU).

The power generation module 13 may include a motor 130 and an engine (not shown in the figure), and the starting module 15 may include a second DC/DC conversion unit 150 and a reverse drive unit 151. A first end of the second DC/DC conversion unit 150 is connected to the starting battery BAT and a second end of the controllable switch Q1, a second end of the second DC/DC conversion unit 150 is connected to a first end of the reverse drive unit 151, and a second end of the reverse drive unit 151 is connected to the motor 130. The second DC/DC conversion unit 150 is configured to perform voltage conversion on electric energy provided by the starting battery BAT or the energy storage device 20, and then supply power to the reverse drive unit 151. The reverse drive unit 151 is configured to control the motor 130 to be started. The second DC/DC conversion unit 150 may include any one of a boost circuit, a buck circuit, and/or a buck-boost circuit.

In an embodiment, the motor 130 may be an alternator. The reverse drive unit 151 may include a DC/AC circuit, configured to convert a direct current voltage output by the second DC/DC conversion unit 150 into an alternating current voltage, and then output the alternating current voltage to a winding of the motor 130, so that a rotor of the motor 130 rotates to reversely drive the engine, to enable the engine to start to operating, to perform energy conversion, to perform conversion into electric energy by using the motor 130, and to output a corresponding voltage after the power conversion module 170 converts the electric energy.

When the controllable switch Q1 is turned on and the motor 130 is not started, the energy storage device 20 supplies power to the second DC/DC conversion unit 150 through the charging terminal 101. When the controllable switch Q1 is turned off and the motor 130 is not started, the starting battery BAT supplies power to the second DC/DC conversion unit 150.

The power supply module 16 may be a voltage conversion circuit, configured to: when the motor 130 is started, convert a voltage output by the motor 130 into a direct current voltage, and then charge the starting battery BAT, and supply power to the second power supply terminal VB2 of the first control module 12. In an embodiment, the motor 130 may be an alternator, and in this case, the power supply module 16 may be an AC/DC circuit. In another embodiment, the motor 130 may alternatively be a direct-current generator, and the power supply module 16 may include, for example, any one of a boost circuit, a buck circuit, and/or a buck-boost circuit.

In some embodiments, the power conversion module 17 may include a power conversion unit 170 and a third DC/DC conversion unit 171. A first end of the power conversion unit 170 is connected to an output end of the motor 130, a second end of the power conversion unit 170 is connected to a first end of the third DC/DC conversion unit 171, and a second end of the third DC/DC conversion unit 171 is connected to the discharging terminal 102. The power conversion unit 170 is configured to perform power conversion on a voltage output by the motor 130. The second end of the power conversion unit 170 outputs a direct current. The third DC/DC conversion unit 171 is configured to perform voltage conversion on a direct current output by the power conversion unit 170 and then output the direct current to the discharging terminal 102, to charge the energy storage device 20 connected to the discharging terminal 102.

The power conversion unit 170 may include any one or at least one of an AC/DC conversion circuit or a DC/DC conversion circuit. It may be understood that a specific circuit structure of the power conversion unit 170 may be determined based on a type of the motor 130. When the motor 130 is a direct-current motor 130, the power conversion unit 170 may include at least a DC/DC conversion circuit. When the motor 130 is an alternating-current motor 130, the power conversion unit 170 may include at least an AC/DC conversion circuit.

The second control module 18 may be connected to the power conversion unit 170 and the third DC/DC conversion unit 171. The second control module 18 is configured to: when the motor 130 is started, control the power conversion unit 170 and the third DC/DC conversion unit 171 to work.

In some embodiments, the generator 10 may further include a direct-current conversion module 19, and the direct-current conversion module 19 includes a fourth unidirectional conduction unit D4 and a fourth DC/DC conversion unit 190. A first end of the fourth unidirectional conduction unit D4 is connected to the charging terminal 101, a second end of the fourth unidirectional conduction unit D4 is connected to a first end of the fourth DC/DC conversion unit 190, and a second end of the fourth DC/DC conversion unit 190 is connected to the first power supply terminal VB1, the first end of the controllable switch Q1, and the second control module 18. A voltage provided by the energy storage device 20 to the charging terminal 101 is provided to the fourth DC/DC conversion unit 190 through the fourth unidirectional conduction unit D4 for voltage conversion, to supply power to the first control module 12 and the second control module 18, and to charge the starting battery BAT when the controllable switch Q1 is turned on.

It may be understood that, the fourth unidirectional conduction unit D4 may include a diode, an anode of the diode is the first end of the fourth unidirectional conduction unit D4, and a cathode of the diode is the second end of the fourth unidirectional conduction unit D4. The fourth DC/DC conversion unit 190 may be a buck circuit, to buck the voltage provided by the energy storage device 20 to the charging terminal 101. For example, the fourth DC/DC conversion unit 190 may buck the voltage of the charging terminal 101 to 14 V, so that a voltage received by the first power supply terminal VB1 of the first control module 12 is 14 V.

In some embodiments, the communication terminal 122 may further include a CAN bus terminal (CANH and CANL shown in FIG. 4), and the control unit 121 may implement a communication connection to the energy storage device 20 by using the CAN bus terminal, to exchange information with the energy storage device 20.

It may be understood that, in this embodiment of this application, the discharging terminal 102, the charging terminal 101, and the communication terminal 122 of the generator 10 may be disposed in a same interface, and the energy storage device 20 is connected to the generator 10 through one interface, to implement a connection of the energy storage device 20 to the discharging terminal 102, the charging terminal 101, and the communication terminal 122 of the generator 10.

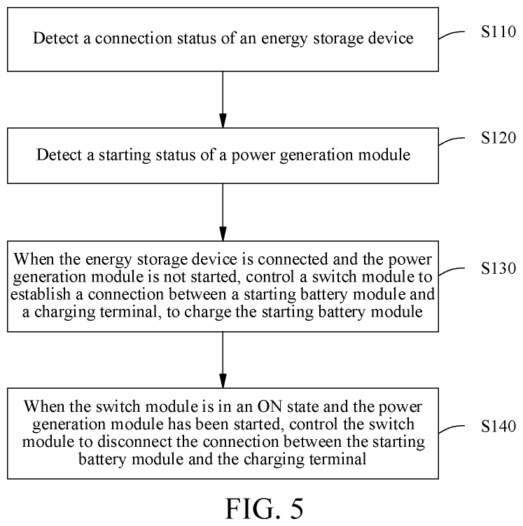

Refer to FIG. 5. FIG. 5 is a flowchart of a control method for a generator according to this application. In at least one implementation, the control method may be configured to be applied to the generator 10 shown in FIG. 1 to FIG. 4. Descriptions are provided below by using an example in which the control method should be configured to be applied to the generator 10 shown in FIG. 1 to FIG. 4.

Specifically, the control method for a generator provided in this application may include the following steps S110 to S130, and the following describes the steps.
S110: Detect a connection status of an energy storage device.

The connection status of the energy storage device 20 may be detected by detecting a voltage and pressure of a charging terminal 101, or the connection status of the energy storage device 20 may be determined by detecting a signal of a communication terminal 122 through which the generator 10 is communicatively connected with the energy storage device 20.
S120: Detect a starting status of a power generation module.

In some embodiments, the power generation module 13 includes a motor 130. For example, the starting status of the power generation module 13 may be detected by detecting rotation of the motor 130. Alternatively, the starting status of the power generation module is determined by detecting a winding current of the motor 130. Status detection of the power generation module 13 is not limited in this application.
S130: When the energy storage device is connected and the power generation module is not started, control a switch module to establish a connection between a starting battery module and the charging terminal, to charge the starting battery module.

In the control method for the generator 10 provided in this application, the connection status of the energy storage device 20 and the starting status of the power generation module 13 are detected, and when the energy storage device 20 is connected and the power generation module 13 is not started, the switch module 14 is controlled to establish the connection between the starting battery module 11 and the charging terminal 101, so that the energy storage device 20 charges the starting battery module 11. In this way, when the energy storage device 20 is connected to the generator 10 and the power generation module 13 is not started, the energy storage device 20 may be configured to charge the starting battery module 11, to prevent the starting battery module 11 from failing to be electrically started because power is exhausted when the power generation module 13 is in a standby state, thereby reducing a case in which a user needs to start the generator 10 by a manual pulling operation, and improving user experience.

It may be understood that referring to FIG. 5 again, the control method may further include step S140.
S140: When the switch module is in an ON state and the power generation module has been started, control the switch module to disconnect the connection between the starting battery module and the charging terminal.

When the power generation module 13 has been started, the power generation module 13 may work to generate electric energy. In this case, the power generation module 13 may charge the starting battery module 11, and the energy storage device 20 does not need to charge the starting battery module 11. Therefore, the switch module 14 may be controlled to disconnect the connection between the starting battery module 11 and the charging terminal 101.

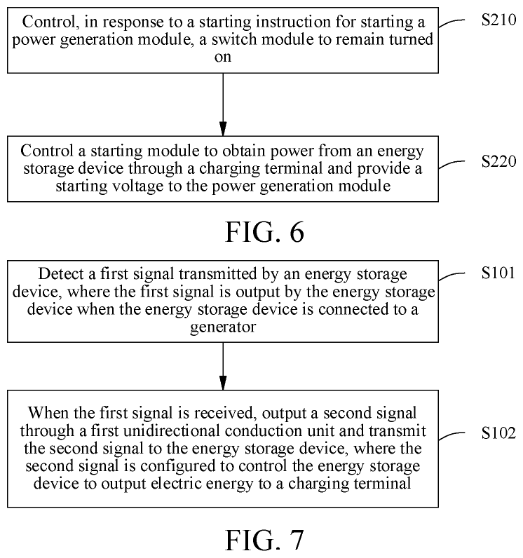

Refer to FIG. 6. In some embodiments, the control method for the generator 10 may further include the following steps.
S210: Control, in response to a starting instruction for starting the power generation module, the switch module to remain turned on.

The starting instruction may be transmitted by the energy storage device 20 to the first control module 12 in a wireless communication manner or a wired communication manner (for example, via a CAN bus terminal of a communication terminal 122).
S220: Control a starting module to obtain power from the energy storage device through the charging terminal and provide a starting voltage to the power generation module.

In this case, when the energy storage device 20 charges the starting battery module 11 through the switch module 14 that is in an ON state, if the generator 10 receives the starting instruction for the power generation module 13, the energy storage device 20 can further supply power to the starting module 15 through the charging terminal 101 and the switch module 14, to provide the starting voltage for the power generation module 13.

Refer to FIG. 7. In some embodiments, the control method for the generator 10 may further include the following steps.
S101: Detect a first signal transmitted by the energy storage device, where the first signal is output by the energy storage device when the energy storage device is connected to the generator.

In the generator 10 shown in FIG. 4, after the energy storage device 20 is connected to the generator 10, the energy storage device 20 is connected to the communication terminal 122 of the first control module 12, and transmits the first signal to the first communication terminal T1 of the communication terminal 122.
S102: When the first signal is received, output a second signal through the first unidirectional conduction unit and transmit the second signal to the energy storage device, where the second signal is configured to control the energy storage device to output electric energy to the charging terminal.

The first unidirectional conduction unit D1 outputs the second signal to the second communication terminal T2 of the communication terminal 122 based on the first signal, and the energy storage device 20 receives the second signal via the second communication terminal T2, so that the energy storage device 20 determines to implement a hardware handshake with the generator 10, and further outputs electric energy to the charging terminal 101 based on the second signal.

The following describes the control method for the generator 10 in this application in detail by using FIG. 4 as an example.

When the energy storage device 20 is connected to the generator 10, the energy storage device 20 transmits a first signal to the first communication terminal T1. The first unidirectional conduction unit outputs a second signal to the second communication terminal T2 based on the first signal. The energy storage device 20 receives the second signal via the second communication terminal T2, and outputs a direct current to the charging terminal 101 based on the second signal.

The fourth DC/DC conversion unit 190 converts the direct current output by the energy storage device 20 to the charging terminal 101 into a 14 V voltage, and outputs the 14 V voltage to the first power supply terminal VB1 of the first control module 12 and the second control module 18, to supply power to the first control module 12 and the second control module 18, and to charge the starting battery BAT through the controllable switch Q1.

The first DC/DC conversion unit 123 performs voltage conversion on the 14 V voltage input by the first power supply terminal VB1, converts the 14 V voltage into a 5 V voltage, and outputs the voltage 5 V to the voltage regulation unit 124. The voltage regulation unit 124 converts the 5 V voltage into a 3.3 V voltage, and provides the 3.3 V voltage to the power supply unit of the control unit 121, so that the control unit 121 is electrically activated and starts to be run.

The control unit 121 detects a status of the motor 130 and a connection status of the energy storage device 20, and when detecting that the motor 130 is not started and the energy storage device 20 is connected, controls the controllable switch Q1 to be turned on, so that the fourth DC/DC conversion unit 190 can transmit the electric energy provided by the energy storage device 20 to the starting battery BAT so as to charge the starting battery BAT.

When the energy storage device 20 has a charging requirement, a user may send a starting instruction to the energy storage device 20 through an application (APP) of the energy storage device 20. The energy storage device 20 transmits the starting instruction to the control unit 121 in a wired communication (communication interface) manner or a wireless communication manner, and then the control unit 121 transmits the starting instruction to the second control module 18. The second control module 18 controls the starting module 15 to start to work. The starting module 15 performs voltage conversion on the 14 V voltage provided by the fourth DC/DC conversion unit 190 and then provides a starting voltage to the motor 130, so that the motor 130 is started. The power conversion module 17 may perform power conversion on electric energy generated by the motor 130. Then the electric energy is output to the discharging terminal 102 to charge the energy storage device 20.

After the motor 130 is started, the control unit 121 controls the controllable switch Q1 to be turned off, and the electric energy generated by the motor 130 supplies power to the starting battery BAT, the second power supply terminal VB2 of the first control module 12, and the second control module 18 through the power supply module 16.

In some embodiments, the control unit 121 may further transmit a related signal to the energy storage device 20, so that the energy storage device 20 stops outputting electric energy to the charging terminal 101.

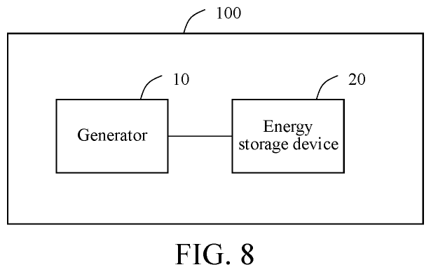

Refer to FIG. 8. An embodiment of this application further provides a power generation and energy storage system 100, including an energy storage device 20 and the generator 10 described above. The generator 10 is electrically connected to the energy storage device 20, and electric energy generated by the generator 10 may be used to charge the energy storage device 20.

When the generator 10 is in a standby state, the energy storage device 20 may charge a starting battery module 11 inside the generator 10.

This application further provides an electronic device, including a processor and a memory. The memory stores executable instructions of the processor. The processor is configured to perform the foregoing control method by executing the executable instructions.

This application further provides a computer-readable storage medium, having a computer program stored therein. The computer program, when executed by a processor, implements the foregoing control method.

The processor may be a central processing unit (CPU), and may further be another general-purpose processor, a digital signal processor (DSP), an application specific integrated circuit (ASIC), a field-programmable gate array (FPGA) or another programmable logic device, a discrete gate or a transistor logic device, a discrete hardware component, or the like. The general-purpose processor may be a microprocessor, any conventional processor, or the like.

The memory may be configured to store computer programs and/or modules. The processor implements various functions of the generator 10 by running or obtaining the computer program and/or module stored in the memory and invoking data stored in the memory. The memory may mainly include a program storage area and a data storage area. The program storage area may store an operating system, an application program required by at least one function (for example, a power on/off function and a key processing function), and the like. The data storage area may store data or the like created according to the use of the generator 10. In addition, the memory may include a non-volatile memory, for example, a hard disk, a memory, a plug-in hard disk, a smart media card (SMC), a secure digital (SD) card, a flash card, at least one magnetic disk storage device, a flash memory device, or another non-volatile solid-state storage device.

The memory may be an external memory and/or an internal memory of the generator 10. Further, the memory may be a physical memory, such as a memory module, a trans-flash (TF) card, or the like.

When the program code and various data in the memory are implemented in the form of a software functional unit and sold or used as an independent product, the integrated unit may be stored in a computer-readable storage medium. Based on such understanding, all or some of the processes in the method of the foregoing embodiments, for example, the control method for a generator 10, may be implemented by a computer program instructing relevant hardware in this application. The computer program may be stored in a computer-readable storage medium. When the computer program is executed by a processor, steps of the foregoing method embodiments may be implemented. The computer program includes computer program code. The computer program code may be in the form of source code, object code, and an executable file, some intermediate forms, or the like. The computer-readable medium may include any entity or apparatus capable of carrying the computer program code, a recording medium, a USB flash disk, a mobile hard disk, a magnetic disk, an optical disk, a computer memory, a read-only memory (ROM), and the like.

The embodiments of this application are described above in detail with reference to the drawings. However, this application is not limited to the foregoing embodiments. Within the scope of knowledge possessed by a person skilled in the art, various modifications may further be made without departing from the spirit of this application.

What is claimed is:

1. A generator, wherein the generator comprises a starting battery module, a first control module, a power generation module, a switch module, and a charging terminal, wherein
the charging terminal is configured to be connected to an energy storage device, to obtain electric energy from the energy storage device;
the switch module is connected between the starting battery module and the charging terminal, and is configured to establish or disconnect a connection between the starting battery module and the charging terminal; and
the first control module is configured to: when the energy storage device is connected and the power generation module is not started, control the switch module to establish a connection between the starting battery module and the charging terminal, to charge the starting battery module.

2. The generator according to claim 1, wherein a first power supply terminal of the first control module is connected to the charging terminal, to receive power supplied by the energy storage device; and the first control module is configured to be activated based on power supplied by the energy storage device and be powered up for running.

3. The generator according to claim 1, wherein the generator further comprises a starting module, and the starting module is connected between the switch module and the power generation module; and
the starting module is configured to: when the switch module is in an ON state, in response to a start instruction for starting the power generation module, obtain power from the energy storage device through the charging terminal and provide a starting voltage to the power generation module.

4. The generator according to claim 2, wherein the generator further comprises a starting module, and the starting module is connected between the switch module and the power generation module; and
the starting module is configured to: when the switch module is in an ON state, in response to a start instruction for starting the power generation module, obtain power from the energy storage device through the charging terminal and provide a starting voltage to the power generation module.

5. The generator according to claim 3, wherein the generator further comprises a power supply module, one terminal of the power supply module is connected to the power generation module, and the other terminal of the power supply module is connected to the starting battery module and a second power supply terminal of the first control module; and
the power supply module is configured to: when the power generation module has been started, convert an output voltage of the power generation module, charge the starting battery module, and supply power to the first control module.

6. The generator according to claim 4, wherein the generator further comprises a power supply module, one terminal of the power supply module is connected to the power generation module, and the other terminal of the power supply module is connected to the starting battery module and a second power supply terminal of the first control module; and
the power supply module is configured to: when the power generation module has been started, convert an output voltage of the power generation module, charge the starting battery module, and supply power to the first control module.

7. The generator according to claim 1, wherein the generator further comprises a discharging terminal, the discharging terminal is connected to the power generation module, and the discharging terminal is configured to be connected to the energy storage device to charge the energy storage device; and
after being started, the power generation module is configured to charge the connected energy storage device through the discharging terminal.

8. The generator according to claim 1, wherein the first control module further comprises a first unidirectional conduction unit, and the first control module is further configured to:
detect a first signal transmitted by the energy storage device, wherein the first signal is output by the energy storage device when the energy storage device is connected to the generator; and
when the first signal is received, output a second signal through the first unidirectional conduction unit and transmit the second signal to the energy storage device, wherein the second signal is configured to control the energy storage device to output electric energy to the charging terminal.

9. A control method for a generator, applied to the generator according to claim 1, wherein the control method comprises:
detecting a connection status of the energy storage device;
detecting a starting status of the power generation module; and
when the energy storage device is connected and the power generation module is not started, controlling the switch module to establish a connection between the starting battery module and the charging terminal, to charge the starting battery module.

10. The control method according to claim 9, wherein the control method further comprises: when the switch module is in an ON state and the power generation module has been started, controlling the switch module to disconnect the connection between the starting battery module and the charging terminal.

11. The control method according to claim 9, wherein the generator further comprises a starting module, and the starting module is connected between the switch module and the power generation module; and
the control method further comprises:
controlling, in response to a start instruction for starting the power generation module, the switch module to remain in the ON state; and
controlling the starting module to obtain power from the energy storage device through the charging terminal and providing a starting voltage to the power generation module.

12. The control method according to claim 9, wherein the first control module further comprises a first unidirectional conduction unit, and the control method further comprises:
detecting a first signal transmitted by the energy storage device, wherein the first signal is output by the energy storage device when the energy storage device is connected to the generator; and
when the first signal is received, outputting a second signal through the first unidirectional conduction unit and transmitting the second signal to the energy storage device, wherein the second signal is configured to control the energy storage device to output electric energy to the charging terminal.

13. A power generation and energy storage system, comprising an energy storage device and the generator according to claim 1.
